(19) United States
(12) Patent Application Publication
(10) Pub. No.: US 2012/0037707 A1
(43) Pub. Date: Feb. 16, 2012

(54) Security informational article with improved features

(75) Inventor: Yoram Curiel, New York, NY (US)

(73) Assignee: GLOBAL SECURITY TECHNOLOGIES, INC.

(21) Appl. No.: 12/806,401

(22) Filed: Aug. 12, 2010

(51) Int. Cl. G06K 19/16; G06K 19/07

(52) U.S. Cl. 235/488

(57) ABSTRACT

The present invention provides a secure identification card 10 having multiple layers, including a layer 20 of holographic images, a layer 30 of ink/images below layer 20, a layer 40 which is a selective white layer below layer 30, a layer 50 of selective metallization below layer 40, a white continuous layer 60 below layer 50, a selective black ink layer 70 below layer 60, and the protective article backing layer 80 below layer 70.

### FIELD OF THE INVENTION

The present invention relates to secure informational articles that cannot be replicated or forged; that will self destruct during attempts at forgery; that will render the photograph on the article as clearly compromised in response to attempts to replicate them; and that can be customized to meet the standards of any organization's security needs.

### BACKGROUND OF THE INVENTION

Although secure informational articles are well known, they have a number of drawbacks which are overcome by the present invention. For example, the present invention provides a hologram containing covert data, and multiple layers of metallization on the cards, including a selectively metalized hologram embedded in the plastic substrate of the card. In addition, the present invention provides encapsulating secure information in a visually verifiable form that cannot be reproduced, since the metalized image on the article cannot be replicated by any currently available printing apparatus.

### OBJECTS OF THE INVENTION

An object of the present invention is to provide a secure informational article such as secure identification cards, decals, gaming chips, card keys for unlocking safes, and other secure articles containing information that cannot be replicated or forged and that will self destruct during attempts at forgery.

Another object of the present invention is to provide a secure identification document that renders the photograph on the article as clearly compromised in response to attempts to replicate them.

Another object of the present invention is to provide a secure identification document that can be customized to meet the standards of any organization's security needs.

Another object of the present invention is to provide a secure identification document having a holograph containing covert data.

Another object of the present invention is to provide a secure identification document having multiple layers of metallization on the cards for increased security, including a metalized hologram embedded in the plastic substrate of the card.

Another object of the present invention is to provide a secure identification card which encapsulates secure information in a visually verifiable form that cannot be reproduced, since the metalized image on the article cannot be replicated.

### SUMMARY OF THE INVENTION

The present invention provides a secure identification document such as a card 10 having multiple layers, including a layer 20 of holographic images, a layer 30 of ink/images below layer 20, a layer 40 which is a selective white layer below layer 30, a layer 50 of selective metallization below layer 40, a white continuous layer 60 below layer 50, a selective black ink layer 70 below layer 60, and the protective article backing 80 below layer 70.

### DESCRIPTION OF THE DRAWINGS

FIG. 1 is a cross sectional view of the informational article when used as an identification card of the present invention;

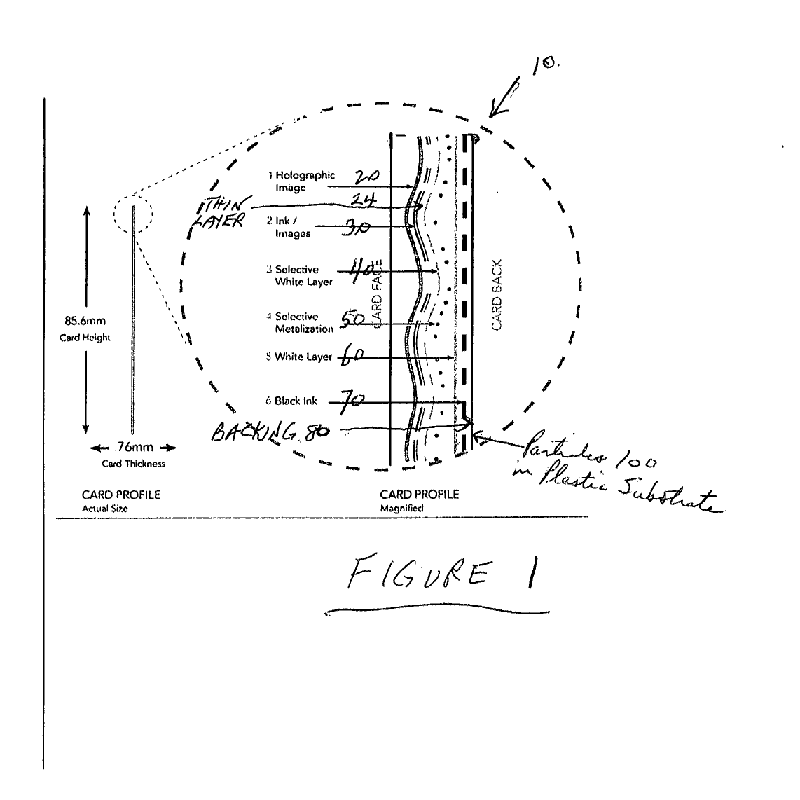

FIG. 2 is a further view of the present invention; and

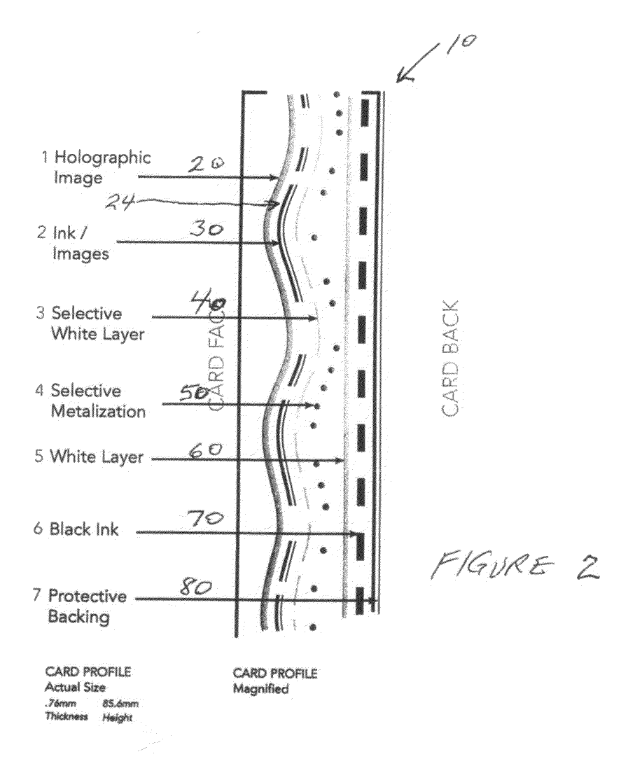

FIG. 3 is a further view of the present invention.

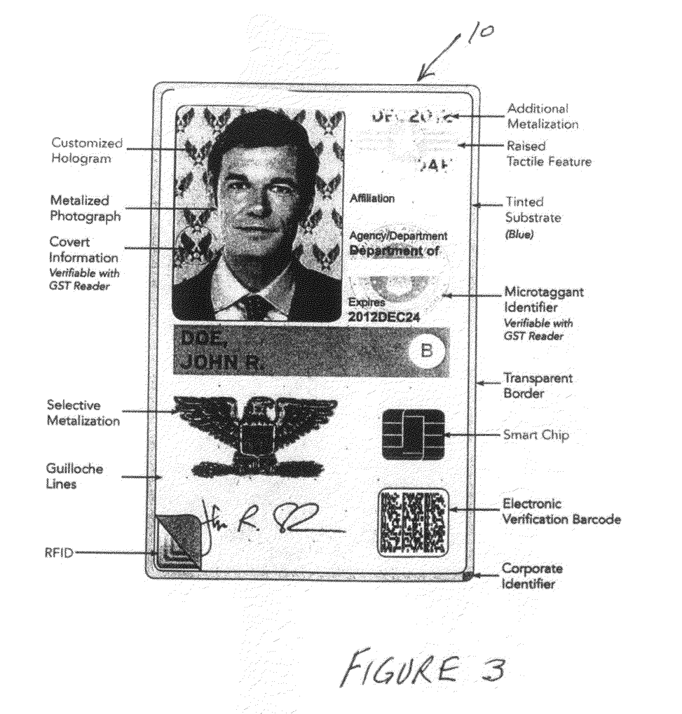

### DESCRIPTION OF THE PREFERRED EMBODIMENT

The present invention provides a secure identification document such as a card 10 having multiple layers, including a layer 20 of holographic images, a layer 30 of ink/images below layer 20, a layer 40 which is a selective white layer below layer 30, a layer 50 of selective metallization below layer 40, a white continuous layer 60 below layer 50, a selective black ink layer 70 below layer 60, and the protective article backing 80 below layer 70.

### Microtaggant Identifier

During the compounding of the plastic substrate microscopic particles 100 of complex chemicals are mixed within the plastic and during forensic examination, the particles become evident under UV and IR (infrared) laser light. The particles 100 are embedded into the card's plastic layer 110. When the article is viewed under an Ultra Violet short wave illuminator/reader 120, the particles 110 are visible to a naked eye. When the microscopic particles 110 are illuminated by a specific Infra Red Laser, the particles 110 glow in bright green flashes. This provides a unique forensic specific layer of authentication.

In addition, the security card or article can be authenticated with applicant's Reader 120, which is a hand held and portable verification device. A red laser, an Infra Red laser and a UV light are used to verify covert information, and a high density UV light identifies the cards particles (microtaggants). In addition, the security articles can be verified with the use of a standard metal detector wand.

### Covert Information

In addition, the present invention provides covert information that may be embedded within a multigram 130 (a multiple holographic images layered together and are individually visible, one at a time only, in sequence as the article is rotated). The Multigram provides good protection from copying and imitation which is organization-specific and can only be read by the Reader 120.

### Transparent Border

In addition, the present invention provides a transparent border 140 around the perimeter of the article which presents an additional layer of security. The border 140 has a width of 1.5 to 0.5 mm. Such a transparent border adds another dimension to the visual security of the article.

To implement this feature is simple. One must raise it toward a light source, and the easy examination will show the light through the transparent area around the article. This provides an additional dimension to the visual authentication of the article, and the result is absolutely positive. As all conventional ID cards are made of opaque blanks, this transparent border 140 makes it more difficult to counterfeit the article.

### Electronic Verification Barcode

In addition, the present invention provides a square see through bar code 150 which provides a unique Electronic detailed Identification for each Article ensuring that the personal information can be read by a coded Bar Code reader. Additionally, this feature provides assurance that information printed on the card's front and back at different production cycles are identical. This barcode 150 provides customized electronic verification for each individual article user. Another security feature of this Bar Code is that it contains substantially more information than the visually printed data thereby allowing on site verification of the identity of the person carrying the card. The square barcode 150 has a preferred dimension of 12 mm on each side.

### Manufacturer Identifier

In addition, the present invention provides a visible indentation 160 into the corner of the article containing a very small alpha numeric figure, as an integrated part of the mold cavity. This indentation 160 makes it more difficult to counterfeit the card because the only way to include it in the card is by making it during the injection molding itself. The square notch 160 has a preferred dimension of 2.5 mm on each side.

### Customized Hologram

In addition, the present invention provides corporate logos and text 170 that can be added to the article using customized holographic masking.

This hologram customization is unique because it permits a very diverse customization of the visible holographic image without the need to remanufacture the entire hologram.

The present invention provides an image cutout of a mask carefully placed inside the metalization machine, and it allows the metal particle generated by the metalization plasma to reach only certain areas as determined by the graphic design of the mask.

The present invention controls the management of placement of such a mask and the proper contact of the mask with the article during metallization which is critical and very hard to achieve. Failure to maintain proper contact causes disfiguring and blurring of the metalized image.

### Multiple Metallization Layers

This invention can utilize more than one type of metal, and position it in different sections of the structure of the article to attain its diverse protective measures. There are many metals that are very suitable for use, including Brass, Silver, Aluminum, Copper, and Gold. Some of these metals can be utilized for their metallic color i.e. Brass for its gold color, and Aluminum for is Silvery color. Copper is used when a darker color of metal is needed. Additionally, Titanium Oxide is used to coat a greenish tinted metallization and titanium Nitrate to add a bluish color.

There are many additional examples of available material for metallization.

Furthermore, we can metalize and place consecutive metalized layers as needed. There are at least three places within the structure of the article, where multiple layers may be needed.

Depending on the required strength of image security needed, the first layer of metallization is coated immediately after the injection molding, on the hologram side, before any printing or any other process. This first metallization layer is a very light and thin layer of metal, approximately 10% of the density of the main metallization layer, that is performed after the article is printed. The presence of the metalization at this layer, or its density control the intensity of the holographic image together with the printed image. This makes the article immune from replication and or imitation.

When printed indicia are layered on top of the first thin metallic layer, the hologram becomes very visible in spite of the printing. By making the coated metal layer heavier, the protection from copying becomes stronger.

The purpose of the first thin layer is to make the entire card “copy proof”. The location of this layer is on the hologram side, immediately on top of the 3 dimensional holographic surfaces on the front face of the article.

### Second Layer of Metal

This is the main metallization layer which is applied immediately after the image to be protected has been printed. This post printing layer of metal provides the best protection to JPEG, or to printed alpha-numeric information.

Any attempt to copy or replicate this selectively metalized zone on the article will fail because of it metallic nature. There is no equipment on the market today that replicate by printing such an image.

### Third Layer of Metal

One of the most rare typed of metallization carried out by anyone on any product is the combination of two types of metals onto one image on the same article one on top of the other. There are two benefits to a double metal coating: first, Enhances the Visual Security because it creates a very special visual effect, and thereby increases the article security. There is a very limited number of organizations that are capable of carrying out such a process especially on a selective graphic design format.

The second benefit of this metalized combination of metals is that it is possible to use in electronics. Several such layers of different metal on top of a layer of Silicone provide a better electronic device with a higher speed or greater capacity.

### Fourth Layer of Metal

In addition to the above, the present invention provides three additional types of specific metallizations:
1. The ability to metalize specific words and patterns 180 anywhere on the article for enhanced security and greater organizational identification; and
2. The ability to engrave images into a pre metalized surface by use of a direct

Piazzo Electric printer or a Laser Engraver/printer directly into the upper surface of the metalized layer. Such engraved information together with a combination of metals is novel.
3. One very novel use of the metalization is the inclusion of a high intensity dense metallic layer. By providing a section of the article with a dense layer of metal, any police metal detector can further authenticate the security article.

### Tinted Substrate

In addition, the present invention provides the option to have color tinted Article that can be molded with a transparent tint 190. This coloring process makes it more difficult to counterfeit the card.

### Raised Tactile Feature and Verification by a Blind Person

In addition, the present invention provides a raised image or text 200 above the surface of the card. This makes it instantly verifiable by touch and makes it more difficult to counterfeit the card. The preferred embodiment of this feature is to raise the image or text 200 to approximately 0.1 mm above the surface of the card. This feature can be made in the form of Braille dots for readability by a blind person.

### ADVANTAGES OF THE INVENTION

The present invention provides the advantage of a secure informational article that cannot be replicated, duplicated or imitated by any means, which prevents the forgery of the article. Any attempts to alter any information placed on the article will cause it to self destruct during attempts at forgery.

The present invention provides the advantage of a secure informational article that renders the photograph on the article as clearly compromised in response to attempts to replicate or imitate them.

The present invention provides the advantage of secure identification documents that can be customized to meet the standards of any organization's security needs.

The present invention provides the advantage of secure identification cards having a holograph containing covert data.

The present invention provides the advantage of secure identification cards having multiple layers of metallization on the cards for increased security, including a metalized hologram embedded in the plastic substrate of the card.

The present invention provides the advantage of secure identification cards which encapsulate secure information in a visually verifiable form that cannot be reproduced, since the metalized image on the article cannot be replicated.

The present invention provides the advantage of validation of an ID by a Blind person.

What is claimed is:

1) A secure informational article 10 having multiple layers, comprising:
a) a layer 20 of holographic images;
b) a thin (10%) first metalization layer 24;
c) a layer 30 of ink/images below layer 20;
d) a layer 40 which is a selective white layer below layer 30;
e) a layer 50 having a selective high density metallization zone below layer 40;
f) a white continuous layer 60 below layer 50;
g) a selective black ink layer 70 below layer 60;
h) a protective article backing layer 80 below layer 70; and
i) microscopic particles 100 in the plastic substrate.

2) A secure informational article 10 in accordance with claim 1, wherein covert information is embedded within the holographic images.

3) A secure informational article 10 in accordance with claim 1, further including a transparent border around the perimeter of the article to provide additional security.

4) A secure informational article 10 in accordance with claim 1, further including an electronic verification barcode to provide customized electronic verification for each user of the article.

5) A secure informational article 10 in accordance with claim 1, further including a visible indentation in the corner of the article containing a small alpha numeric figure to provide additional security.

6) A secure informational article 10 in accordance with claim 1, further including corporate logos and/or text using holographic masking to customize the article.

7) A secure informational article 10 in accordance with claim 1, wherein the metallization layer uses brass, silver, aluminum, copper, or gold.

8) A secure informational article 10 in accordance with claim 1, further including a raised tactile element for use by a blind person.

9) A secure informational article 10 in accordance with claim 1, wherein said plastic substrate is tinted with a selected color.

10) A secure informational article 10 in accordance with claim 1, wherein said article includes a metalized photograph and a metalized logo.

11) A secure informational article 10 in accordance with claim 1, wherein said article includes a smart chip.
